(19) United States
(12) Patent Application Publication
(10) Pub. No.: US 2016/0234222 A1
(43) Pub. Date: Aug. 11, 2016

(54) System Allowing Access to Defined Addressee After Check with Access-List

(71) Applicant: ROSBERG SYSTEM AS, Karmsund, OT (NO)

(72) Inventor: Odd Helge Rosberg, Karmsund (NO)

(73) Assignee: Rosberg System AS, Karmsund, OT (NO)

(21) Appl. No.: 15/022,033

(22) PCT Filed: May 6, 2014
(86) PCT No.: PCT/EP2014/059265

§ 371 Date: Mar. 15, 2016

(30) Foreign Application Priority Data
May 3, 2013 (GB) 1308063.5

(51) Int. Cl. H04L 29/06

(52) U.S. Cl. CPC H04L 63/102; H04L 63/0876

(57) ABSTRACT

An access control system is configured for data communication with at least a first remote service provider via a wide area telecommunications network and for data communication with at least a first local device via local data communication. The access control system is configurable to facilitate data communication between the first remote service provider and the first local device.

This invention relates to an access control system.

### BACKGROUND

In homes and businesses there are a growing number of devices that require remote management, content delivery, data retrieval and other services. One example is metering of electricity and other utilities. Another example is home hospital solutions where medical readings are read securely into an external medical system. A further example is managing computers, printers, servers and connected home and office systems like security, refrigerators, cameras, dishwashers and multiple other devices.

Connecting these devices poses a huge threat in terms of security. There have already been examples of tampering with meter readings from power consumption meters to lower the electricity bill. More serious is the fact that one can disconnect and reconnect power remotely, and the fact that this may be done not only for one customer but for a whole area. Such problems have kept many suppliers from implementing such functionality or limiting this functionality significantly.

The present invention, at least in its preferred embodiments, seeks to provide a simple, scalable and profitable eco-system for infrastructure providers, such as telecommunications companies, to be able to accommodate a growing need to reach devices inside a home, a company and the in a simple and secured way and being able to charge the different operators for that access.

### BRIEF SUMMARY OF THE DISCLOSURE

In accordance with the present invention there is provided an access control system configured for data communication with at least a first remote service provider via a wide area telecommunications network and for data communication with at least a first local device via local data communication, wherein the access control system is configurable to facilitate data communication between the first remote service provider and the first local device.

Thus, in accordance with the invention the access control device facilitates data communication between remote service providers, such as power companies, and local devices, such as electricity meters. Local data communication may be via a local area network.

The system may be configured for data communication with a second remote service provider via a wide area telecommunications network and for data communication with a second local device via local data communication. The access control system may be configurable to facilitate data communication between the second remote service provider and the second local device. In this way, a single access control device can be used to provide data communication for multiple local devices and multiple service providers.

The system may be configured to prevent data communication between the first remote service provider and the second local device and to prevent data communication between the second remote service provider and the first local device. Thus, a particular service provider may be limited to data communication with only specified local devices.

The system may be configured to receive a connection request from the remote service provider. The connection request may include an identifier of the remote service provider. The system may be further configured to reject the connection request, and in response to the received connection request to compare the received identifier to a predefined list of identifiers for authorised remote service providers. If the identifier matches an identifier on the list, the system may be configured to identify a predefined address for the remote service provider, the address having been stored previously by the access control system, and to establish data communication with the predefined address. This provides a particularly secure access protocol that prevents unauthorised access.

In response to a successful connection request from a remote service provider, the system may be configured to establish data communication with a local device associated with the remote service provider.

The system may be configured to send a connection request to the local device, the connection request including an identifier of the system. The local device may be configured to reject the connection request, and in response to the received connection request to compare the received identifier to a predefined list of identifiers for authorised access control systems. If the identifier matches an identifier on the list, the local device may be configured to identify a predefined address for the access control system, the address having been stored previously by the local device, and to establish data communication with the predefined address. This ensures that a particular local device can only be accessed by a particular access control system.

The system may be configured to receive a connection request from the local device, the connection request including an identifier of the local device. The system may be further configured to reject the connection request, and in response to the received connection request to compare the received identifier to a predefined list of identifiers for authorised local devices. If the identifier matches an identifier on the list, the system may be configured to identify a predefined address for the local device, the address having been stored previously by the system, and to establish data communication with the predefined address. In response to a successful connection request from a local device, the system may be configured to establish data communication with a remote service provider associated with the local device.

The system may comprise a plurality of virtual machines, each configured to manage data communication between at least one respective remote service provider and at least one respective local device.

At least one local device may be a metering device, for example an electricity meter or water meter. At least one local device may be a medical sensor.

The invention extends to computer software which configures general-purpose data processing apparatus to operate as an access control system as described above.

### BRIEF DESCRIPTION OF THE DRAWINGS

Embodiments of the invention are further described hereinafter with reference to the accompanying drawings, in which:

FIG. 1 is a schematic representation of an access control device according to an embodiment of the invention;

FIG. 2 is a schematic representation of the operation of the access control device of FIG. 1; and

FIG. 3 is a further schematic representation of the operation of the access control device of FIG. 1.

### DETAILED DESCRIPTION

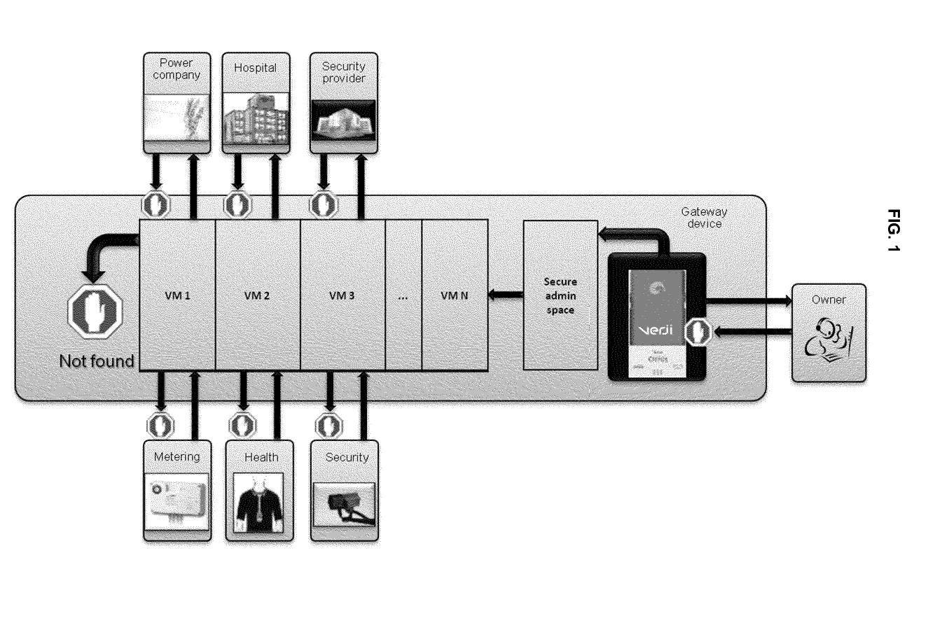

FIGS. 1 to 3 show schematically an access control system for remote management of multiple devices according to an embodiment of the invention. As shown in FIG. 1, the access control system is in the form of a gateway device comprising a plurality of virtual machines, VM1 . . . VMN. The device comprises a secure administration space for configuring the operation of the virtual machines. The owner of the gateway device can connect to the gateway device via an owner interface in order to set access controls and the like. The term “virtual machine” (VM) as used herein indicates the software engine that controls connections, which may be any suitable means capable of performing the required functionality.

The owner of the gateway device may also be the local area network owner, i.e. a customer rather than a service provider or a telecommunications company. The secure administration space in the gateway device may be divided into several parts where one belong to the network provider, for example a telecommunications company, and one to the owner of the house, company etc.

The gateway device is in data communication via a local area network with a plurality of local devices (represented in FIG. 1 as “metering”, “health” and “security”). The gateway device is also in data communication via a wider area network, such as the Internet, with a plurality of service providers (represented in FIG. 1 as “power company”, “hospital” and “security provider”). Each virtual machine manages data communication between a respective service provider and a respective local device. For example, the power company is able to communicate with metering devices. The use of respective virtual machines ensures that a service provider can only communicate with the local devices for which it is authorised. For example, the power company cannot access security devices.

In this embodiment, data communication connections between the service providers and the gateway device are established according to a version of the access protocol described in our patent application WO 2010/039041. According to this protocol, a service provider sends a connection request to the gateway device which includes an identifier for the service provider. The connection request is rejected (as indicated by the hand symbol in FIG. 1). However, the virtual machine compares the received identifier with a predefined list of authorised identifiers, each of which is associated with a predefined address for the authorised service provider. If the received identifier is on the list, the virtual machine sends a connection request to the associated predefined address, which will be accepted by the service provider to establish the data connection. If the received identifier is not found in the list, the connection process terminates. In this way, unauthorised access to the gateway device is prevented because the gateway device will not accept an incoming connection but will only make connections to predefined addresses. The owner is able to connect to the gateway device using a similar protocol.

Similarly, the local devices are configured to reject incoming connection requests and only connect back to the gateway device. To connect to a local device, the gateway device sends a connection request to the local device which includes an identifier for the gateway device (or virtual machine). The connection request is rejected by the local device (as indicated by the hand symbol in FIG. 1). However, the local device compares the received identifier with a predefined list of authorised identifiers, each of which is associated with a predefined address for the gateway device. If the received identifier is on the list, the local device sends a connection request to the gateway device, which will be accepted by the gateway device to establish the data connection.

Depending on the level of security required, alternative connection protocols may be used.

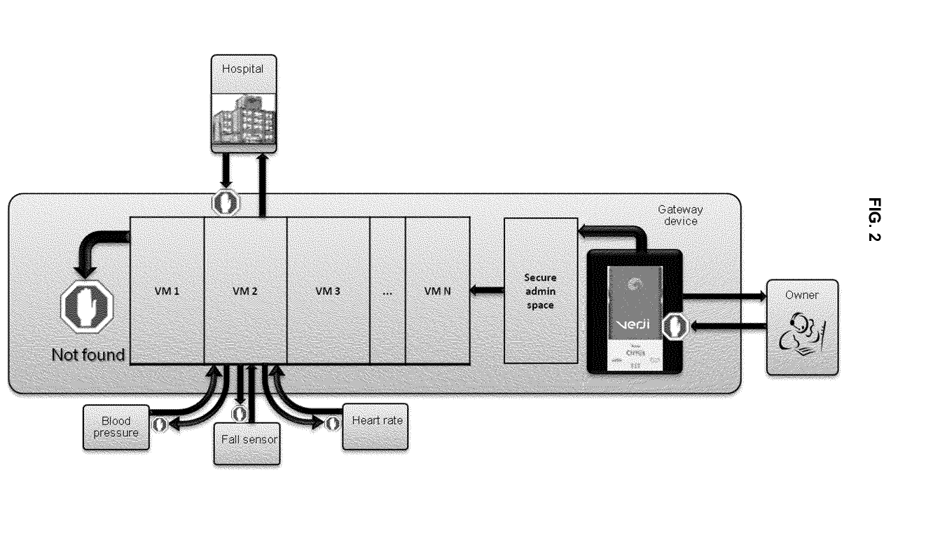

As shown in FIG. 2, multiple local devices may communicate with a service provider via a virtual machine. In the example shown, a blood pressure monitor, a sensor indicating a patient has fallen and a heart rate monitor each communicate with a hospital.

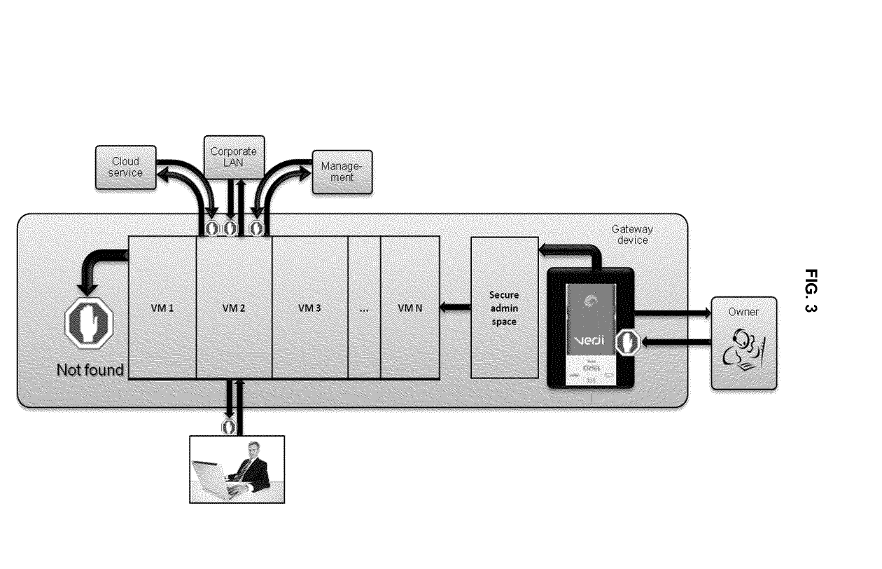

Similarly, as shown in FIG. 3, multiple service providers may communicate with a single local device via a virtual machine. In the example shown, a user laptop communicates with a “cloud” data storage service, a corporate LAN and a management service provider.

The local devices may be connected to the gateway device via a local area network, which may be a corporate network, a home network, a personal area network, an in-car network, etc. The local area network may be wired, wireless or a combination of both. The gateway device provides secured access to the local devices in a standardized way while giving the owner of the gateway device complete control over the access rights to the local devices. In this way, instead of having one box for water metering, one for power metering, one for security systems and one for remote access to the network a single gateway device provides all of this secure access in a configurable manner.

The owner of the local devices and the gateway device sets the parameters of the access for different service providers. These include:
Access rights to the local devices;
Allowed service providers, identified by caller-ID (caller line identification), IP-address or other identifiers;
Actions to perform, such as like starting a virtual machine, starting a virtual application, setting up communication, secured communication if needed, e.g. via VPN, credential checks and other security actions;
A list of local devices or types of devices within the networked environment that a service provider is allowed to see;
Creation and transfer of virtual machines, virtual applications, partial virtualization, para-virtualization and any other method of making a secured secluded environment for the different accesses in the gateway device.

The service provider may provide the local device, such as an electricity meter, within a customer's local area network. Access to the local device is then strictly regulated within the local device so that only the owner of the local device, e.g. the service provider, is allowed access to the setup of the device. The setup consists of deploying a table comprising:
Allowed external identifiers, which may be any ID depending on the usage of the local device, for example caller-ID, IP address, Instant Message ID (using XMPP or similar technologies);
An address to connect the service provider to a specific virtual machine if the callback protocol described above is used;
Instructions on how to connect the service provider (callback, type of communication to use, which virtual machine to use, security checks, establishing a VPN connection or any other kind of command or set of commands).
Allowed internal ID or ID's for the local device(s) the service provider wishes to contact within the customer's network, which may be any ID depending on the usage of the local device, for example caller-ID, IP address, Instant Message ID (using XMPP or similar technologies);
An address to connect the local device to a specific virtual machine if the callback protocol described above is used;
Instructions on how to connect the local device (callback, type of communication to use, which virtual machine to use, security checks, establishing a VPN connection or any other kind of command or set of commands);
Instructions for scheduled connections to local devices for reporting back information to service providers for purposes such as metering, usage statistics, sensor instances or any other information relayed back to the service provider on a regular basis; and
Event-based relay of information where the local device connects to the gateway device when certain events occurs, such as alarms, usage threshold limits being exceeded or any other event suited to trigger such an action.

The setup also includes deploying a VM or set of VM's using a virtual machine manager (VMM) or a hypervisor or similar technology to install one or a set of virtual machines that are completely isolated from each other. This may alternatively be done using virtual applications in a similarly isolated environment, a combination or using other methods of separating the different accesses from each other. These engines are then connected using the information in the table above.

The virtual machines are designed to only access a certain local device or certain local devices inside the customer's network. This is to prevent the service provider from accessing anything inside the customer's network beside the ones defined. This may be done in several ways, ranging from low level security solutions, such as MAC address range filtering, where a certain manufacturer has a certain range of MAC addresses to UUID (universally unique identifier) or more advanced methods using keys and tokens or other secure methods of identifying devices.

A local device can be set up to contact the specified VM in response to specified events, such as reaching a threshold value or when data needs to be delivered to the server. If the VM in the gateway device is not started, the hypervisor will start it to allow it to receive and relay the data to the correct service provider.

There may also be settings where a local device needs to talk to two or more of the VM's, an example of this may be a laptop that use one VM to communicate to a cloud service, another to communicate with the hospital and beside that has a connection to the internet using a default gateway. In this setting the local device either has an ID in each application, or an agent providing the intelligence needed or both.

In the same way one may also set up the gateway device to communicate with several local devices. One exemplification may be in a company where several multifunction devices communicate with one VM for servicing and usage reports.

The definition of an internal network may not only be a traditional network, but also a virtual network where devices are roaming, or several LAN's connected together. This may be achieved by traditional techniques such as VPN but also using mesh, instant messaging protocols (such as XMPP) or other similar technologies.

In summary, an access control system is configured for data communication with at least a first remote service provider via a wide area telecommunications network and for data communication with at least a first local device via local data communication. The access control system is configurable to facilitate data communication between the first remote service provider and the first local device.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An access control system configured for data communication with at least a first remote service provider via a wide area telecommunications network and for data communication with at least a first local device via local data communication, wherein the access control system is configurable to facilitate data communication between the first remote service provider and the first local device.

2. An access control system as claimed in claim 1, wherein the system is configured for data communication with a second remote service provider via a wide area telecommunications network and for data communication with a second local device via local data communication, and wherein the access control system is configurable to facilitate data communication between the second remote service provider and the second local device.

3. An access control system as claimed in claim 2, wherein the system is configured to prevent data communication between the first remote service provider and the second local device and to prevent data communication between the second remote service provider and the first local device.

4. An access control system as claimed in claim 1, wherein the system is configured to receive a connection request from the remote service provider, the connection request including an identifier of the remote service provider, to reject the connection request, and in response to the received connection request to compare the received identifier to a predefined list of identifiers for authorised remote service providers, and, if the identifier matches an identifier on the list, to identify a predefined address for the remote service provider, the address having been stored previously by the access control system, and to establish data communication with the predefined address.

5. An access control system as claimed in claim 1, wherein in response to a successful connection request from a remote service provider, the system is configured to establish data communication with a local device associated with the remote service provider.

6. An access control system as claimed in claim 1, wherein the system is configured to send a connection request to the local device, the connection request including an identifier of the system, the local device is configured to reject the connection request, and in response to the received connection request to compare the received identifier to a predefined list of identifiers for authorised access control systems, and, if the identifier matches an identifier on the list, to identify a predefined address for the access control system, the address having been stored previously by the local device, and to establish data communication with the predefined address.

7. An access control system as claimed in claim 1, wherein the system is configured to receive a connection request from the local device, the connection request including an identifier of the local device, the system is configured to reject the connection request, and in response to the received connection request to compare the received identifier to a predefined list of identifiers for authorised local devices, and, if the identifier matches an identifier on the list, to identify a predefined address for the local device, the address having been stored previously by the system, and to establish data communication with the predefined address.

8. An access control system as claimed in claim 1, wherein in response to a successful connection request from a local device, the system is configured to establish data communication with a remote service provider associated with the local device.

9. An access control system as claimed in claim 1, wherein the system comprises a plurality of virtual machines, each configured to manage data communication between at least one respective remote service provider and at least one respective local device.

10. An access control system as claimed in claim 1, wherein local data communication is via a local area network.

11. An access control system as claimed in claim 1, wherein at least one local device is a metering device.

12. Computer software which configures general-purpose data processing apparatus to operate as an access control system as claimed in claim 1.
